(19) United States
(12) Patent Application Publication
(10) Pub. No.: US 2026/0291607 A1
(43) Pub. Date: Sep. 24, 2026

(54) OPTICAL WIRELESS COMMUNICATION SYSTEM

(71) Applicant: TOYOTA JIDOSHA KABUSHIKI KAISHA, Aichi-ken (JP)

(72) Inventors: Shintaro SHIBA, Tokyo-to (JP); Norimasa KOBORI, Tokyo-to (JP)

(21) Appl. No.: 19/562,768

(22) Filed: Mar. 11, 2026

(30) Foreign Application Priority Data
Mar. 21, 2025 (JP) 2025-046476

(51) Int. Cl. H04B 10/11; H04W 4/024; H04W 64/00

(52) U.S. Cl. CPC H04B 10/11; H04W 4/024; H04W 64/00

(57) ABSTRACT

An optical wireless communication system comprises a plurality of optical sources including a first optical source and a second optical source, a receiving device comprising a camera. Each of the plurality of optical sources transmits an optical wireless communication signal. The receiving device is configured to receive the optical wireless communication signal with the camera. The system is configured to execute an optical source guiding process when a first image acquired by the camera includes the first optical source and does not include the second optical source. The optical source guiding process includes specifying a guiding direction for capturing the second optical source within a view of the camera based at least on the absolute position of the first optical source and the second optical source, and notifying the guiding direction via the receiving device.

### CROSS REFERENCE TO RELATED APPLICATION

This application claims priority to Japanese Patent Application No. 2025-046476 filed on Mar. 21, 2025, the entire contents of which are incorporated by reference herein.

### TECHNICAL FIELD

The present disclosure relates to a wireless communication system that utilizes a plurality of optical sources and a camera.

### BACKGROUND ART

Patent Literature 1 discloses a communication system that concurrently performs self-position estimation and communication. The communication system comprises a plurality of optical sources and a camera. The communication system estimates the position of the camera based on position information of each optical source and coordinates of the optical source in a captured image.

### List of Related Art

Patent Literature 1: Japanese Unexamined Patent Publication No. 2024-111470

### SUMMARY

In order to estimate the position of the camera using a plurality of optical sources, it is necessary for the camera to capture the plurality of optical sources. However, depending on the camera angle, there may be cases where the number of optical sources required for estimating the camera position is not included in the captured image. In such cases, the camera position estimation cannot be appropriately executed.

One object of the present disclosure is to provide a technique to handle a case where the number of optical sources shown in the image captured by the camera is insufficient in a wireless communication system utilizing a plurality of optical sources and a camera.

A first aspect relates to a light wireless communication system.

The optical wireless communication system comprises a plurality of optical sources including a first optical source and a second optical source, a receiving device comprising a camera, and processing circuitry.

Each of the plurality of optical sources transmits an optical wireless communication signal.

The receiving device is configured to receive the optical wireless communication signal with the camera.

The processing circuitry is configured to execute an optical source guiding process when a first image acquired by the camera includes the first optical source and does not include the second optical source.

the optical source guiding process includes:
obtaining a first optical source absolute position, which is an absolute position of the first optical source, and a second optical source absolute position, which is an absolute position of the second optical source, in response to receiving a first wireless communication signal, which is transmitted by the first optical source;
specifying a guiding direction for capturing the second optical source within a view of the camera based at least on the first optical source absolute position and the second optical source absolute position; and
notifying the guiding direction via the receiving device.

The optical source guiding process of the present disclosure notifies the guiding direction for capturing the second optical source, which is not shown in the first image taken by the camera, within the field of view of the camera. A user of the receiving device equipped with the camera can move or tilt the camera in the direction of the second optical source according to the guidance, so that the camera can capture more optical sources.

### BRIEF DESCRIPTION OF DRAWINGS

FIG. 1 is a diagram illustrating an overview of an optical wireless communication system according to one embodiment;

FIG. 2 is a perspective view illustrating a geometrical relationship between absolute positions of optical sources and image positions of the optical sources;

FIG. 3 is a schematic diagram showing a process of acquiring the optical source image position;

FIG. 4 is a graph illustrating characteristics of data frequencies of an optical signal and noise;

FIG. 5 is a diagram illustrating image plane before and after execution of acquisition of the optical source image position and acquisition of the absolute position of the optical source;

FIG. 6 is a schematic diagram illustrating a first embodiment of the optical source guiding process;

FIG. 7 is a schematic diagram illustrating a second embodiment of the optical source guiding process;

FIG. 8 is a block diagram showing a third embodiment of the optical source guiding process;

FIG. 9 is a block diagram corresponding to a fourth embodiment of the optical source guiding process; and

FIG. 10 is a block diagram illustrating a configuration example of the optical wireless communication system.

### DETAILED DESCRIPTION

Referring to the accompanying drawings, embodiments of the present disclosure will be described.

### 1. Basic Configuration

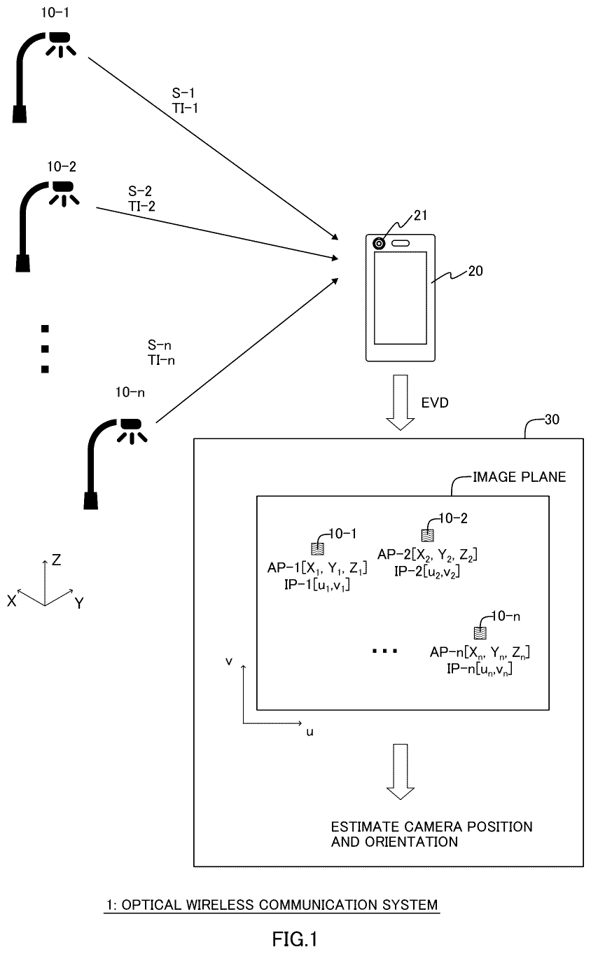

FIG. 1 is a diagram illustrating an outline of an optical wireless communication system 1. The optical wireless communication system 1 includes a plurality of optical sources 10-1 to n (where n is an integer satisfying n≥2), a receiving device 20 provided with an event camera 21, and an information processing device 30.

The plurality of optical sources 10-1 to n are fixedly mounted in space and are installed indoors or outdoors. Examples of a plurality of optical sources 10-1 to n include visible light LEDs (light emitting diodes) and infrared LEDs. Since visible light LEDs are widely used in streetlights, indoor lights, traffic signals, electric display boards, etc., the utilization of visible light LEDs in ca wireless communication system 1 leads to effective use of existing equipment. Since visible light LEDs blink at a speed so high that it cannot be perceived by the human eye, the visible light can be used as a communication signal by controlling such blinking. Typically, the plurality of optical sources 10-1 to n are simultaneously displayed within the view of the event camera 21.

An optical source 10-i (i=1 to n) constituting the plurality of optical sources 10-1 to n transmits a wireless communication signal S-i by blinking. The optical wireless communication signal S-i includes target information TI-i to be delivered. Target information TI-i includes, for example, position information of the optical source 10-i serving as the transmission source. In the drawings of the present disclosure, the absolute coordinate system is represented by the X axis, Y axis, and Z axis. Here, the X-axis and the Y-axis are axes that are orthogonal to each other and define a horizontal plane, and the Z-axis indicates a vertical direction. Further, an optical source absolute position AP-i of the optical source 10-i is represented as [Xi, Yi, Zi]. Hereinafter, “optical wireless communication signal S-i” is simply referred to as “optical signal S-I” for simplicity.

The receiving device 20 receives the optical signal S-i with the event camera 21. Typically, the receiving device 20 simultaneously receives optical signals S-1 to S-n transmitted from each of the plurality of optical sources 10-1 to 10-n. Typical examples of the receiving device 20 include a smartphone, a tablet, a wearable terminal for augmented reality, etc., but not limited to these examples. Any object equipped with the event camera 21 can function as the receiving device 20. For example, a vehicle, a robot, a wheelchair, etc. equipped with the event camera 21 function as the receiving device 20. As described above, the receiving device 20 is typically an object or terminal configured to be movable. When the receiving device 20 moves, the event camera 21 also moves accordingly.

The event camera 21 incorporates an event-based vision sensor (EV sensor). The EV sensor observes changes in luminance of light received by pixels (imaging elements) in the sensor. When the EV sensor observes a luminance change exceeding a predetermined threshold, it detects this luminance change as an “event”. An event is detected when a situation different from the previous situation occurs. For example, when an object or the event camera 21 moves, the relative position between the object and the event camera 21 changes, causing the object to appear in a pixel where it did not exist previously. At this time, since a significant luminance change occurs in pixels around the object, this luminance change is detected as an event. Further, since the optical signal S-i also causes a change in luminance due to the blinking of the optical source 10-i, it is detected as an event.

The event camera 21 outputs data related to pixels in which an event has been detected as event data EVD. The event data EVD includes at least the coordinates on the image plane of the pixel where the event occurred, the time at which the event was detected, and the brightness polarity (plus/minus). A threshold referenced by the EV sensor or detecting events can be set optionally. When an event occurs, threshold on the positive side (change in the bright direction) and the negative side (change in the dark direction) are set based on a voltage (reference voltage) corresponding to the luminance level at that point. A voltage change exceeding the threshold on the positive side is detected as an event of positive polarity, and a voltage change exceeding the threshold on the negative side is detected as an event of negative polarity. That is, the optical signal S-i is detected by the EV sensor such that the timing at which the optical source 10-i turns on is detected as a positive polarity event, and the timing at which the optical source 10-i turns off is detected as a negative polarity event.

The information processing device 30 acquires the event data EVD from the event camera 21. The information processing device 30 obtains the two-dimensional position of the light signal S-i on the image plane using the event data EVD. This two-dimensional position indicates the position where the optical source 10-i is projected onto the image plane. Hereinafter, the position at which an optical source 10-i is projected onto an image plane is referred to as the “optical source image position IP-i,” and the process for acquiring the optical source image position IP-i is referred to as “optical source image position acquisition.” In the present disclosure, the image plane coordinate system is represented by a u-axis and a v-axis. Further, the optical source image position IP-i of the optical source 10-i is represented by [ui, vi]. The information processing device 30 may be included in the receiving device 20, or may be an device external to the receiving device 20.

Furthermore, the information processing device 30 acquires a three-dimensional position (optical source absolute position AP-i) in the absolute coordinate system for the optical source 10-i from object information TI-i included in an optical signal S-i. Hereinafter, a process of obtaining an absolute position AP-i of an optical source is referred to as “optical source absolute position acquisition.” Some examples of the target information TI-i and the optical source absolute position acquisition will be described later.

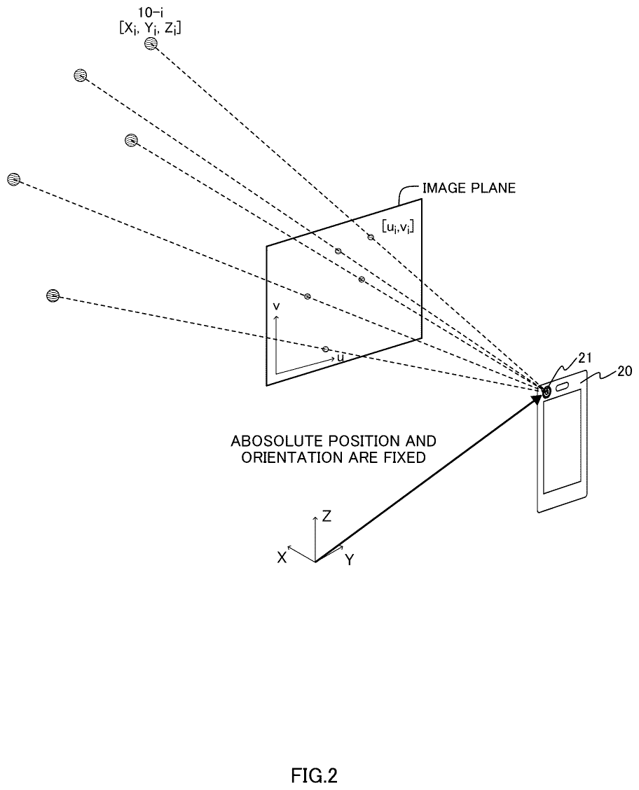

Through the steps described above, the information processing device 30 acquires n sets of data of the optical source absolute positions AP-i ([Xi, Yi, Zi] in FIG. 1) and the optical source image positions IP-i ([ui, vi] in FIG. 1) for the optical source 10-i. FIG. 2 is a perspective view illustrating a geometric relationship between the optical source absolute position AP-i and the optical source image position IP-i. The information processing device 30 estimates a position and an orientation in the absolute coordinate system of the event camera 21 based on the geometric relationships among the n sets of data. More specifically, a rotation matrix and a translation vector are obtained from n sets of data sets. A specific solution method is known as the Perspective n Point (PnP) problem, and the value of the number of required data sets (that is, n) necessary to solve this problem differs depending on the method. For example, a method called the 8-point algorithm (that is, n=8) is known as one solution to such problems. Since the event camera 21 is provided in the receiving device 20, estimating the absolute position and orientation of the event camera 21 is synonymous with estimating the absolute position and orientation of the receiving device 20. Furthermore, when only the position of the event camera 21 is to be estimated, the position is theoretically determined with n=3. For improving estimation accuracy, more optical sources 10-i than the minimum required number may be used.

As described above, an information processing device 30 estimates the absolute position and the orientation of the event camera 21 through the optical source image position acquisition and the optical source absolute position acquisition. This series of process is hereinafter referred to as ‘camera position estimation.’ Existing position estimation systems (for example, satellite positioning systems) may be unable to accurately estimate a position in locations where satellite radio waves are difficult to reach (etc. as inside buildings, underground, or between high-rise buildings). On the other hand, the camera position estimation in the optical wireless communication system 1 does not use satellite radio waves, and therefore the locational restriction is less strict.

### 2. Camera Position Information

Hereinafter, details of a series of process related to the camera position estimation will be explained.

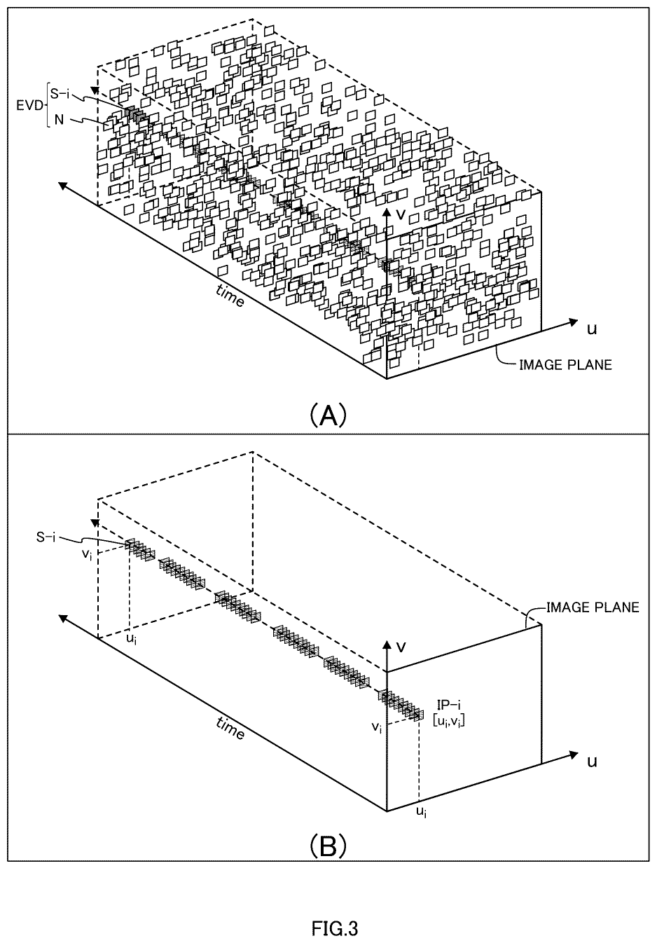

FIG. 3 is a schematic diagram illustrating a process for acquiring the optical source image position acquisition. Part (A) in FIG. 3 is a graph representing a spatiotemporal distribution of event data EVD received by the information processing device 30 from the event camera 21. Event data EVD includes not only events caused by the blinking of the optical source 10-i (that is, a optical signal S-i), but also noise N, i.e., events caused by movement of an object or the event camera 21. That is, the event data EVD is output in a state where the optical signal S-i, which is necessary for the camera position estimation, and noise N, which is unnecessary for camera position estimation, are mixed. Therefore, in order for the information processing device 30 to acquire the optical source image position IP-i, it is necessary to perform signal separation, which is a process of separating the optical signal S-i and the noise N.

As one method of signal separation, a method based on the ‘data frequency’ of the event data EVD for each pixel has been well-known. As described above, the event data EVD includes the time at which an event was detected. Therefore, the information processing device 30 can calculate, for each pixel, the number of event data EVD detected per unit time. The number of event detected per unit time can be referred to as the “data frequency.”

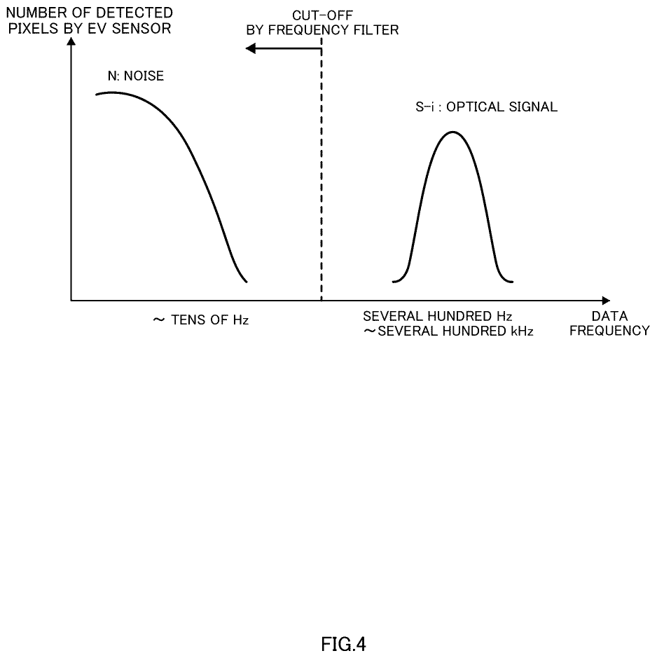

As shown in FIG. 4, the characteristics of the data frequency in the optical signal S-i and noise N are significantly different. The data frequency of the optical signal S-i is linked to the blinking frequency of the optical source 10-i, and its value is approximately several hundred Hz to several hundred kHz. On the other hand, the data frequency of noise N caused by movement of a subject or the event camera 21 is significantly lower (approximately tens of Hz range) than the data frequency due to the optical signal S-i. Therefore, the information processing device 30 can separate the optical signal S-i and the noise N by using a frequency filter. As an example of a frequency filter, a high-pass filter, which cuts signals that are below a predetermined frequency, may be used. In this case, the information processing device 30 determines that a pixel region in which a high data frequency not cut by a high-pass filter has been observed is the signal region occupied by the optical signal S-i.

Part (B) in FIG. 3 is a graph showing the spatiotemporal distribution of the event data EVD after signal separation. As described above, since the event data event includes information on coordinates in the image plane coordinate system, the information processing device 30 can acquire the position of the separated optical signal S-i in the image plane coordinate system. The position of the optical signal S-i in the image plane coordinate system indicates the position at which the optical source 10-i is projected onto the image plane coordinate system, that is, the optical source image position IP-i. In practice, since a signal region occupied by the optical signal S-i on an image plane extends over a plurality of pixels, for example, the central coordinate of the signal region of the optical signal S-i may be regarded as the optical source image position IP-i. In this manner, the optical source image position acquisition is performed.

The optical signal S-i transmitted from the optical source 10-i includes the target information TI-i for specifying the optical source absolute position AP-i. information processing device 30 acquires the optical source absolute position AP-i based on the target information TI-i.

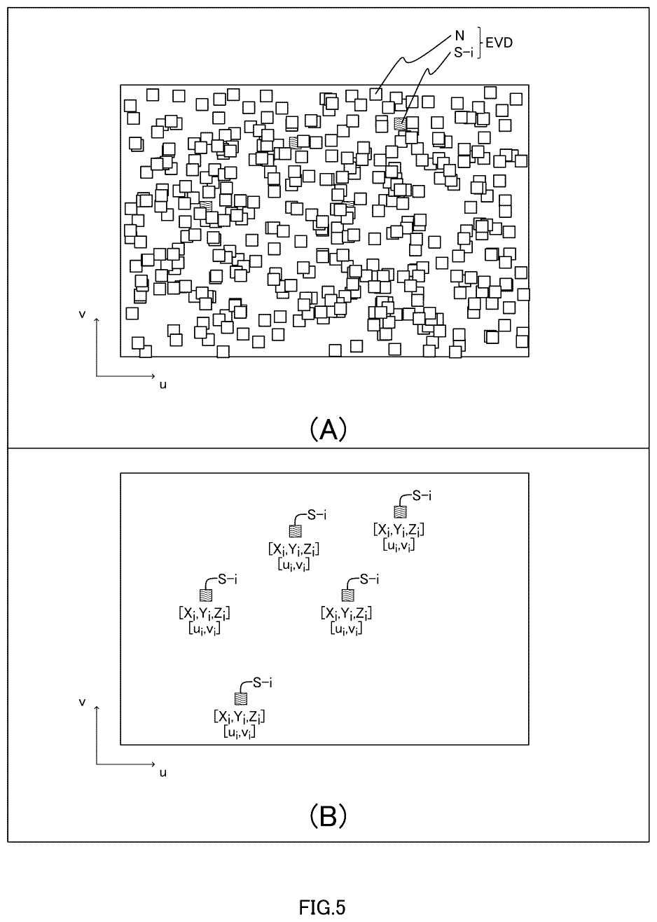

FIG. 5 is a diagram illustrating the image plane before and after executing the optical source image position acquisition and optical source absolute position acquisition. Part (A) in FIG. 5 shows the image plane before executing the optical source image position acquisition and optical source absolute position acquisition, that is, at the point in time when the information processing device 30 has just acquired the event data EVD. At this point, the event data EVD includes the noise N along and the plurality of optical signals S-1 to n transmitted from the plurality of optical sources 10-1 to n.

The information processing device 30 performs signal separation of the optical signal S-i and the noise N, and acquires the position of the optical signal S-i in the image plane coordinate system, that is, the optical source image position IP-i of the optical source 10-i. Further, the information processing device 30 acquires the optical source absolute position AP-i of the optical source 10-i through the optical source absolute position acquisition. As a result of the optical source image position acquisition and the optical source absolute position acquisition, the information processing device 30 acquires the data set of the optical source absolute position AP-i and the optical source image position IP-i with respect to the optical source 10-i, as shown in part (B) of FIG. 5. The information processing device 30 is capable of estimating a position and an orientation in the absolute coordinate system of the event camera 21 based on the geometric relationships derived from these data sets and the focal length of the event camera 21.

### 3. Optical Source Guiding Process

As described above, in order for camera position estimation utilizing the optical wireless communication system 1 to function properly, it is necessary that the plurality of optical sources 10-1 to n be captured within the view of the event camera 21. However, the event camera 21 does not always capture the sufficient number of optical sources required for camera position estimation. The number of optical sources that can be captured depends on the camera angle of the event camera 21. Accordingly, in the case where the number of optical sources captured in the view of the event camera 21 is insufficient, guiding the user of the receiving device 20 so that the optical sources present in the periphery can be captured within the field of view of the event camera 21 is effective. In this section, a situation is considered where the first optical source 10-1 is captured and the second optical source 10-2 is not captured in the first image IMG-1 photographed by the event camera 21. The optical wireless communication system 1 provides a notification via the receiving device 20 in order to guide the user such that the second optical source 10-2 is positioned within the field of view of the event camera 21. This series of process is referred to as the “optical source guiding process.” The optical source guiding process includes acquiring the first optical source absolute position AP-1, which is the absolute position of the first optical source 10-1, and the second optical source absolute position AP-2, which is the absolute position of the second optical source 10-2, in response to reception of the first optical signal S-1 transmitted by the first optical source 10-1. The optical source guiding process further includes specifying a guiding direction 40 for capturing the second light optical source 10-2 within the field of view of the event camera 21 based on at least the first optical source absolute position AP-1 and the second optical source absolute position AP-2. Hereinafter, several embodiments of the optical source guiding process will be described.

### 3-1. First Embodiment

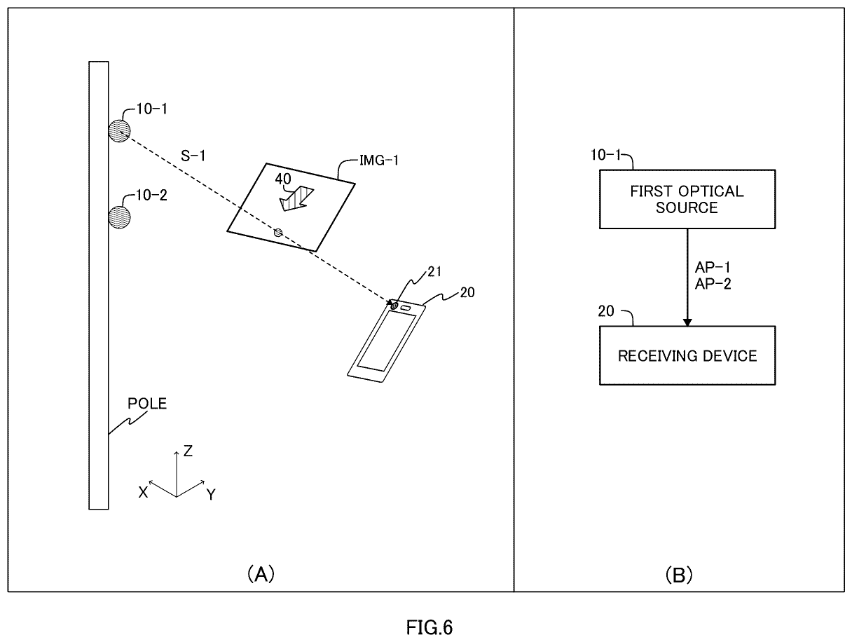

FIG. 6 is a schematic diagram showing a first embodiment of the optical source guiding process. In the first embodiment, the first optical signal S-1 transmitted from the first optical source 10-1 includes information of the first optical source absolute position AP-1 and the second optical source absolute position AP-2. In part (A) of FIG. 6, the first optical source 10-1 and the second optical source 10-2 are installed on the same pole, and the second optical source 10-2 is installed below the first optical source 10-1. The first optical source 10-1 transmits the second optical source absolute position AP-2, which is the absolute position of the second optical source 10-2, in addition to the first optical source absolute position AP-1, which is its own absolute position. The first and second optical source absolute positions are included in the first optical signal S-1 (i.e., the first optical wireless communication signal). Upon receiving the first optical signal S-1, the receiving device 20 specifies the guiding direction 40 based on the first optical source absolute position AP-1 and the second optical source absolute position AP-2. Since the second optical source 10-2 is installed below the first optical source 10-1, the first optical source absolute position AP-1 and the second optical source absolute position AP-2 acquired by the receiving device 20 have substantially identical X coordinates and Y coordinates, while having different Z coordinates. Therefore, the information processing device 30 specifies that the guiding direction 40 is downward. After specifying the guiding direction 40, the information processing device 30 notifies the guiding direction 40 via the receiving device 20. This notification may, as illustrated, be presented as an arrow in the first image IMG-1, or may prompt the user by voice message to face the guiding direction 40. In addition, together with notification of the guiding direction 40, the receiving device 20 may be caused to vibrate, thereby notifying the user that the second optical source 10-2 exists in the periphery of the current event camera 21′s field of view. As described above, when the positional relationship between the first optical source 10-1 and the second optical source 10-2 is limited, the optical wireless communication system 1 can specify the guiding direction 40 based on the first optical source absolute position AP-1 and the second optical source absolute position AP-2. Specifically, the first embodiment functions when both optical sources are installed on the same object (for example, a pole) and the distance between them is close.

Part (B) of FIG. 6 shows a block diagram corresponding to the first embodiment of the optical source guiding process. The first optical source 10-1 transmits the first optical source absolute position AP-1 and the second optical source absolute position AP-2, which included in the first optical signal S-1. The receiving device 20 acquires the first optical source absolute position AP-1 and the second optical source absolute position AP-2 by receiving the first optical signal S-1.

### 3-2. Second Embodiment

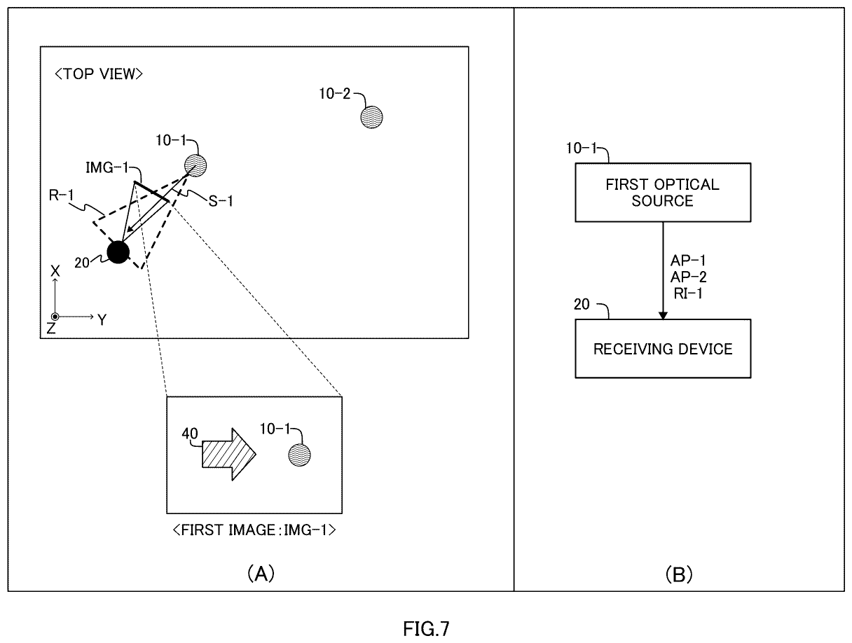

In a second embodiment of the optical source guiding process, the wireless optical communication system 1 utilizes “receiving position limiting information”, which is information to restrict the position of the receiving device 20. Therefore, the information processing device 30 can identify the guiding direction 40 under a broader range of situations. FIG. 7 is a schematic diagram showing the second embodiment of the optical source guiding process.

Part (A) of FIG. 7 is a schematic diagram (top view as seen from the Z direction) showing the positional relationship among the first optical source 10-1, the second optical source 10-2, and the receiving device 20. The first optical source 10-1 and the second optical source 10-2 are positioned apart from each other on the XY plane. As illustrated, the first optical signal S-1 is transmitted within a limited range (first communication range R-1) in a specific direction. That is, the first optical signal S-1 is received when the receiving device 20 is located within the first communication range R-1. The information processing device 30 utilizes first communication range information RI-1, which indicates the first communication range R-1, as receiving position limiting information. The first communication range information RI-1, for example, indicates which direction the first optical signal S-1 is being transmitted from, with reference to the first optical source 10-1 as a center. The first optical signal S-1 includes the first communication range information RI-1 as receiving position limiting information. In other words, the receiving device 20, which receives the first optical signal S-1, can obtain an approximate position of the receiving device 20 itself by referring to the first communication range information RI-1. Specifically, the direction in which the receiving device 20 is positioned with respect to the first optical source 10-1 is determined. When the receiving device 20 receives the first communication range information RI-1, in addition to the first optical source absolute position AP-1 and the second optical source absolute position AP-2, the information processing device 30 can specify the guiding direction 40. In the embodiment illustrated in FIG. 7, in order to capture the second optical source 10-2, which is not shown in the first image IMG-1, within the field of view of the event camera 21, a right-pointing arrow is displayed as the guiding direction 40 in the first image IMG-1.

The receiving device 20 may acquire receiving position limiting information using an external system. For example, a global navigation satellite system (GNSS) is one of such external systems. The information processing device 30 can use the position information of the receiving device 20, acquired from the GNSS, as the receiving position limiting information. As described, in the case of the second embodiment, the information processing device 30 has already obtained the position of the receiving device 20 (that is, the event camera 21) prior to camera position estimation using the optical wireless communication system 1. Nevertheless, it is effective to measure a more accurate position and orientation of the event camera 21 by camera position estimation utilizing the optical wireless communication system 1.

Part (B) of FIG. 7 shows a block diagram in the second embodiment of the optical source guiding process. The first optical source 10-1 transmits the first communication range information RI-1 included in the first optical signal S-1, in addition to the first optical source absolute position AP-1 and the second optical source absolute position AP-2. The receiving device 20 acquires the first communication range information RI-1 by receiving the first optical signal S-1.

When comparing the first and the second embodiment, the first embodiment functions in cases where the guiding direction 40 is determined based on the absolute positions of two optical source (first optical source absolute position AP-1 and second optical source absolute position AP-2), and is therefore particularly effective when the guiding direction 40 is in the vertical direction. On the other hand, the second example is suitable not only for guiding in the vertical direction but also for in the horizontal direction. With information only about the absolute positions of the two optical sources, there may be cases in which the guiding direction 40 cannot be specified unless the positional relationship between the first optical source 10-1 and the receiving device 20 is determined. In the second embodiment, the information processing device 30 can grasp a positional relationship between the first optical source 10-1 and the receiving device 20 by utilizing the reception position limiting information.

### 3-3. Third Embodiment

A third embodiment of the optical source guiding process utilizes a database DB. The optical wireless communication system 1 acquires information necessary for the optical source guiding process (the first optical source absolute position AP-1, the second optical source absolute position AP-2, the first communication range R-1, etc.) from the database DB. In this case, the first optical source 10-1 transmits first identification information ID-1, corresponding to the first optical source 10-1, which is included in the first optical signal S-1.

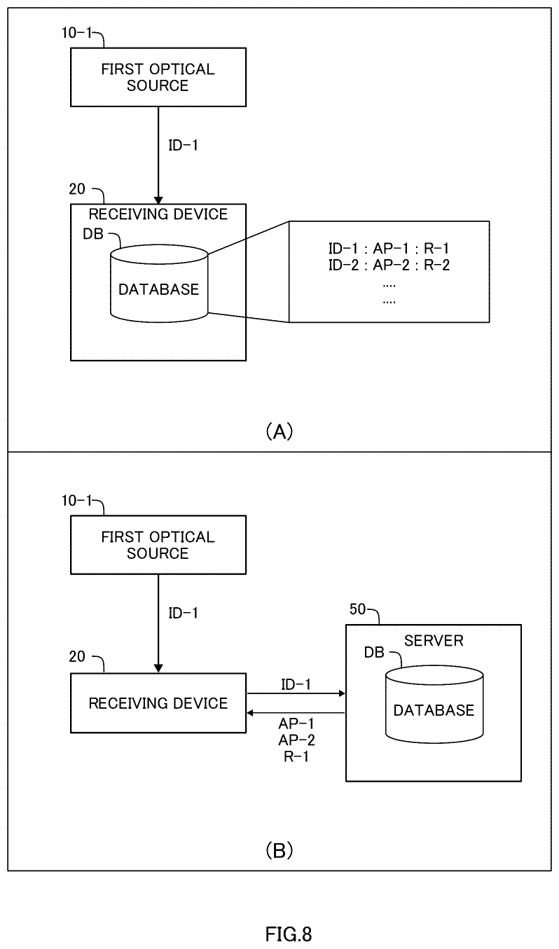

FIG. 8 is a block diagram illustrating a third embodiment of the optical source guiding process. In Part (A) of FIG. 8, the receiving device 20 includes database DB. The database DB retains information corresponding to each optical source 10-i. In the embodiment of FIG. 8, the database DB records the first optical source absolute position AP-1 and the first communication range R-1 in correspondence with the first identification information ID-1, and the second optical source absolute position AP-2 and the second communication range R-2 in correspondence with the second identification information ID-2. A second identification information ID-2 and a second communication range R-2 respectively indicate identification information of the second optical source 10-2 and a communication range of the second optical source 10-2. The receiving device 20, having acquired the first identification information ID-1, refers to the database DB to obtain the first optical source absolute position AP-1 and the first communication range R-1 corresponding to the first identification information ID-1. The receiving device 20 also acquires the second optical source absolute position AP-2, which is the absolute position of the second optical source 10-2, based on the first optical source absolute position AP-1. A receiving device 20, for example, selects a optical source 10-i located within a predetermined distance from the first optical source 10-1 as the second optical source 10-2 to be subjected to the optical source guiding process. The receiving device 20 may preferentially select a optical source 10-i that is closer from the first optical source 10-1 as the second optical source 10-2. The information processing device 30 thus acquires the information necessary for the optical source guiding process.

The database DB may be included in a server 50 which is different from the receiving device 20, as illustrated in part (B) in FIG. 8. In this case, the receiving device 20 transmits the first identification information ID-1 to the server 50 and acquires the information necessary for the optical source guiding process from the server 50 via communication.

### 3-4. Fourth Embodiment

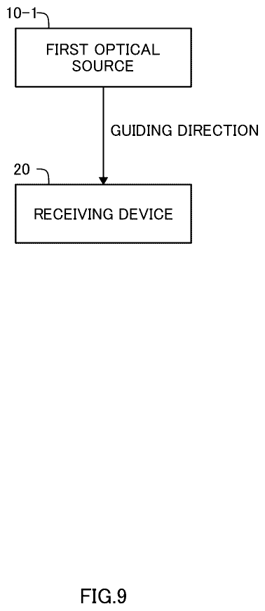

In a fourth embodiment of the optical source guiding process, the first optical source 10-1 transmits the first optical signal S-1 that directly includes the guiding direction 40. The fourth embodiment is effective in a case where the guiding direction 40 is predetermined based on a positional relationship between the first optical source 10-1 and the second optical source 10-2. For example, in case of part (A) of FIG. 6 or part (A) of FIG. 7, when it is confirmed that the positional relationship between the first optical source 10-1 and the second optical source 10-2 does not change over a long period, it is permissible to directly include the guiding direction 40 in the first optical signal S-1. FIG. 9 is a block diagram corresponding to a fourth embodiment of the optical source guiding process. The first optical source 10-1 transmits the first optical signal S-1 including the guiding direction 40.

### 3-5. Effect

The optical source guiding process effectively works when the information processing device 30 performs a process utilizing the optical signals S-1 to n transmitted from the plurality of optical source 10-1 to n. The aforementioned camera position estimation is a typical example of such a process. When a sufficient number of optical source cannot be captured in a certain camera angle, the optical source guiding process notifies the guiding direction 40, so that the user can move the receiving device 20 in such a way that the event camera 21 can capture more of the optical source 10-i. That is, the optical source guiding process makes camera position estimation more reliable.

When both the first optical source 10-1 and the second optical source 10-2 are simultaneously captured, the information processing device 30 does not need to execute the optical source guiding process. Specifically, when both the first optical source 10-1 and the second optical source 10-2 are already captured in the first image IMG-1 in the initial camera angle, or as a result of the optical source guiding process, if the event camera 21 is able to capture both optical sources, the optical source guiding process is not necessarily executed. In this case, notification indicating the guiding direction 40 is also unnecessary. Whether an optical source 10-i is present in a first image IMG-1 can be determined by whether the receiving device 20 receives the corresponding optical signal S-i. For example, a state in which the first optical source 10-1 is present in the first image IMG-1 and the second optical source 10-2 is not present in the first image IMG-1 corresponds to a state in which the receiving device 20 is receiving the first optical signal S-1 and not receiving the second optical signal S-2. When the first optical source 10-1 and the second optical source 10-2 are captured in the first image IMG-1, the optical wireless communication system 1 may notify the user to the fact. As a result, when the event camera 21 captures both light optical source after the optical source guiding process, the user can recognize that. This notification may be displayed as a message on the first image IMG-1, or may be provided as a voice notification.

### 4. Example Configuration of Optical Communication System

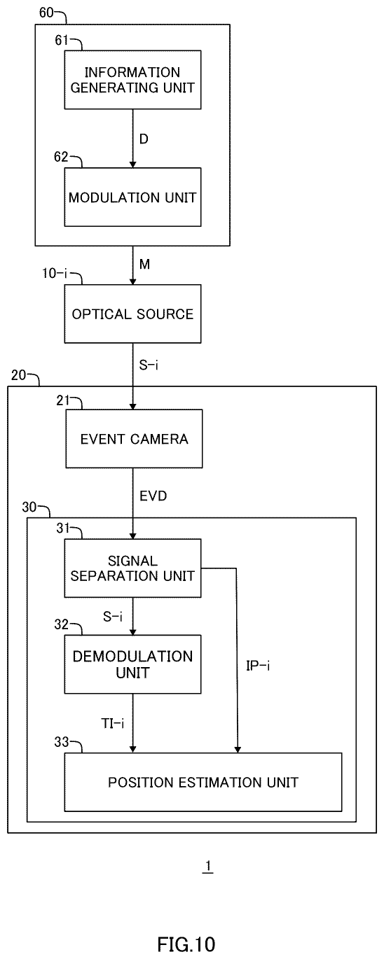

FIG. 10 is a block diagram illustrating an example configuration of the optical wireless communication system 1.

The blinking control device 60 controls blinking patterns of the optical source 10-i. The blinking control device 60 may be incorporated in equipment having the optical source 10-i (such as streetlights, traffic signals, indoor lighting, etc.). Alternatively, the blinking control device 60 may be included in an external equipment (such as a management server), and may control the blinking of the optical source 10-i from outside. Furthermore, when the blinking control device 60 is provided in an external equipment, it may collectively control the blinking of the plurality of optical source 10-1 to n.

The information generating unit 61 generates a digital signal D. The digital signal D is a signal that represents target information TI-i in binary values of “0” and “1”. The generated digital signal D is output to a modulation unit 62.

The modulation unit 62 generates a modulation signal M by modulating the digital signal D into a signal suitable for optical wireless communication. As the modulation scheme, a pulse width modulation (PWM), a pulse position modulation (PPM), and the like is used. PWM is a method which controls a time ratio between ON (lighting) and OFF (extinguishing) of a optical source 10-i in accordance with an input signal. PPM is a method which controls the position on a time axis of a carrier pulse by an input signal.

The blinking control device 60 supplies the modulation signal M to the optical source 10-i. The optical source 10-i flickers according to the modulation signal M. The optical signal S-i is a signal indicated by the blinking pattern of the optical source 10-i represented by the modulation signal M.

The receiving device 20 receives the optical signal S-i via the event camera 21. Specifically, the EV sensor incorporated in the event camera 21 detects a change in luminance caused by the optical signal S-i as an event. The receiving device 20 transmits event data EVD to a signal separation unit 31 in the information processing device 30.

In FIG. 10, the information processing device 30 is included in the receiving device 20. The information processing device 30 executes a subsequent series of process based on the received event data EVD. The information processing device 30 may be a device different from the receiving device 20 (for example, an external server). In this case, the receiving device 20 and the information processing device 30 transmit information to each other via communication.

The signal separation unit 31 performs a process of separating the optical signal S-i and noise N included in event data EVD (i.e., the aforementioned signal separation) to acquire the optical source image position IP-i. The optical source image position IP-i is output to a position estimation unit 33.

The demodulation unit 32 demodulates the optical signal S-i separated by the signal separation unit 31 to acquire the target information TI-i. The demodulation unit 32 provides the target information TI-i to the position estimation unit 33.

The position estimation unit 33 acquires the optical source absolute position AP-i based on the target information TI-i. For example, as shown in FIG. 6 or FIG. 7, when the optical source absolute position AP-i is directly transmitted as the target information TI-i, the position estimation unit 33 directly acquires the optical source absolute position AP-i. Further, as shown in FIG. 8, when identification information is transmitted as the target information TI-i, the information processing device 30 accesses the database DB to acquire a optical source absolute position AP-i corresponding to the identification information. The information processing device 30 acquires n sets of data for the optical source absolute position AP-i and the optical source image position IP-i regarding the optical source 10-i. The information processing device 30 estimates the position and the orientation of the event camera 21 in the absolute coordinate system of the event camera 21 from the geometric relationship among these n sets of data.

The optical wireless communication system 1 comprises one or more processors (hereinafter simply referred to as “processor”). The processor is included in the blinking control device 60 and the information processing device 30, and executes each process required for the optical wireless communication system 1. The processor executes a process of acquiring the optical source absolute position AP-i and the optical source image position IP-i, the optical source guiding process, camera position estimation, etc. Examples of the processor include a general-purpose processor, a special-purpose processor, a CPU (Central Processing Unit), a GPU (Graphics Processing Unit), an ASIC (Application Specific Integrated Circuit), an FPGA (Field Programmable Gate Array), integrated circuits, conventional circuits, and/or combinations thereof. The processor may also be referred to as circuitry or processing circuitry.

What is claimed is:

1. An optical wireless communication system, comprising:
a plurality of optical sources including a first optical source and a second optical source;
a receiving device comprising a camera; and
processing circuitry, wherein each of the plurality of optical sources transmits an optical wireless communication signal,
the receiving device is configured to receive the optical wireless communication signal with the camera,
the processing circuitry is configured to execute an optical source guiding process when a first image acquired by the camera includes the first optical source and does not include the second optical source, and
the optical source guiding process includes:
obtaining a first optical source absolute position, which is an absolute position of the first optical source, and a second optical source absolute position, which is an absolute position of the second optical source, in response to receiving a first wireless communication signal, which is transmitted by the first optical source;
specifying a guiding direction for capturing the second optical source within a view of the camera based at least on the first optical source absolute position and the second optical source absolute position; and
notifying the guiding direction via the receiving device.

2. The optical wireless communication system according to claim 1, wherein the first optical wireless communication signal includes:
information indicating the first optical source absolute position; and
information indicating the second optical source absolute position.

3. The optical wireless communication system according to claim 1, wherein
the optical source guiding process further including:
acquiring receiving position limiting information that limits a position of the receiving device; and
specifying the guiding direction based at least on the first optical source absolute position, the second optical source absolute position, and the receiving position limiting information.

4. The optical wireless communication system according to claim 3, wherein
the first optical wireless communication signal is transmitted within a first communication range limited to a specific direction,
the receiving position limiting information includes first communication range information indicating the first communication range.

5. An optical wireless communication system, comprising:
a plurality of optical sources including a first optical source and a second optical source;
a receiving device comprising a camera; and
processing circuitry, wherein the first optical source transmits a first optical wireless communication signal,
the first optical wireless communication signal is transmitted within a first communication range limited to a specific direction,
the receiving device is configured to receive the first optical wireless communication signal with the camera,
the first optical wireless communication signal includes information indicating a guiding direction for capturing the second optical source within a view of the camera,
the processing circuitry is configured to execute an optical source guiding process, and
the optical source guiding process includes:
determining the guiding direction with reference to the first communication range and a second optical source absolute position, which is an absolute position of the second optical source; and
notifying the guiding direction via the receiving device.
